(19) United States
(12) Patent Application Publication
(10) Pub. No.: US 2005/0241905 A1
(43) Pub. Date: Nov. 3, 2005

(54) Torsional return spring for a clutch

(76) Inventors: Jeffrey Alan Duwel, Plymouth, MI (US); Ronald Warren Wangerow, Novi, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(21) Appl. No.: 10/837,011

(22) Filed: Apr. 30, 2004

(51) Int. Cl. F16F 1/06; F16D 25/0638

(52) U.S. Cl. 192/70.28; 267/180; 192/85 AA

(57) ABSTRACT

A torsional spring system is provided and is made from a single wire having a first end and a second end, and being wound to define a plurality of coil sections each separated from one another by a plurality of torsion arms. The first and second ends of the wire are joined to one another such that the plurality of coil sections and the plurality of torsion arms combine to form a loop. The torsion spring of the present invention can be utilized as a return spring in a clutch system for reducing the cost of the overall assembly. In addition, the torsion spring of the present invention also provides added functionality by being capable of simultaneously counteracting any combination of axial, radial, and rotational forces.

### FIELD OF THE INVENTION

The present invention relates to friction clutches, particularly for use in the drivetrain of an automotive transmission, and more particularly, to a torsional return spring for an actuator piston of such a clutch.

### BACKGROUND OF THE INVENTION

Clutch assemblies have been used in automatic transmission for vehicles for many years. As illustrated in FIG. 1, the typical clutch design includes a first member 112 and a second member 114 rotatable relative to the first member. A clutch pack 116 including at least one first clutch disk 118 attached to the first member 112 and at least one second clutch disk 120 attached to the second member 114 is provided for selectively, frictionally engaging the first and second members 112, 114. In an automotive transmission, the first and second members 112, 114 can be any one of a rotating shaft, gears, and planetary gearing system components, or a fixed non-rotatable member, such as a housing. In a typical friction clutch assembly, an apply piston 122 is disposed in a fluid chamber 124 for selectively applying axial pressure on the clutch pack 116. A return spring mechanism 126 typically in the form of a spring pack, wave spring, or Bellville spring is used to apply a biasing force against the apply piston to bias the apply piston to a disengaged position. The input into the system is hydraulic pressure delivered to the piston chamber 124 and acting directly on the apply piston 122. The apply piston 122 translates toward the friction plates 118, 120 coming into contact with the plates and applying pressure thereto. The pressure applied to the friction plates 118, 120 increases and eventually causes the rotation of the component for which the system is designed to engage.

The apply piston pressure must overcome the force of the return spring 126 in order to apply pressure to the clutch pack. The return spring's main function is to return the apply piston into the disengaged position from which it came after the apply pressure has dissipated in order to disengage the clutch. As shown in FIG. 1, the spring pack 126 includes a pair of opposing annular retainer plates 128 which encapsulate a plurality of coil springs 132 therebetween. One of the retaining plates 128 is disposed against the apply piston 122 while a second of the retaining plates 130 is disposed against a retaining component 134. The spring pack 126 requires the complex stamping of the two retaining plates 128, 130 as well as the forming of the plurality of coil springs 132. In addition, the assembly of the spring pack 126 is a relatively complex operation. In a typical spring pack 126, twenty or more coil springs 132 may be utilized in spaced relationship around the circumference of the spring pack 126. Although the spring packs 126, and other Bellville-type springs, are satisfactory for providing a return spring function, a less expensive and less complex return spring system is desirable.

### SUMMARY OF THE INVENTION

The present invention provides a torsion spring which is capable of being utilized as a return spring in a clutch system which can be formed from a single wire having a first and a second end which is wound to define a plurality of coil sections each separated from one another by a plurality of torsion arms. The first and second ends of the wire are joined to one another such that the plurality of coil sections and the plurality of torsion arms combine to form a loop. The torsion arms are utilized to provide a return spring function to a clutch pack while the torsion spring does not require additional retaining components as is required in a standard spring pack. Because the torsional spring of the present invention can be formed utilizing standard garter spring forming techniques, the cost of producing the torsion spring, according to the principles of the present invention, is greatly reduced in comparison to the cost of forming the standard spring packs. Relative to a collection of helical coil springs, the present invention provides significant product design flexibility in that minor changes to the geometry of the spring will result in the ability to provide linear or non-linear characteristics, as desired in a given application.

The torsional spring design of the present invention also provides increased functionality in any application which requires a controlled resistance to one, two, or even three types of forces simultaneously, including any one or more of axial compressive forces, radial forces, and rotational forces. The spring of the present invention is capable of applying all or any of these forces simultaneously with a single spring device. Since the present invention integrates any combination of these three forces in one spring, and incorporating one spring instead of two or more springs provides a significant reduction in cost.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view of an exemplary prior art clutch assembly utilizing a spring pack for a return spring acting on an apply piston of the clutch;

FIG. 2 is a partial cross-sectional view of a clutch similar to the one shown in FIG. 1, with the spring pack replaced by a torsional spring according to the principles of the present invention;

FIG. 3 is a top plan view of a torsional spring according to the principles of the present invention;

FIG. 4 is a cross-sectional view taken along line 4-4 of FIG. 3, and illustrating an optional reinforcing component added inside of the looped wire to provide additional stiffness according to the principles of the present invention;

FIG. 5 is a cross-sectional view of a section of a torsional spring according to the principles of the present invention wherein the curved torsion arms provide a variable moment arm length for providing a specific spring characteristic according to the principles of the present invention;

FIG. 6 is a schematic diagram illustrating the variable moment arm length obtainable with the torsion spring shown in FIG. 5;

FIG. 7 is a plan view of an alternative torsion spring design according to the principles of the present invention;

FIG. 8 is a cross-sectional view taken along line 8-8 of FIG. 7;

FIG. 9 is a plan view of a third alternative embodiment of the torsion spring according to the principles of the present invention;

FIG. 10 is a cross-sectional view taken along line 10-10 of FIG. 9;

FIG. 11 is a perspective view of a torsion spring according to the principles of the present invention, and illustrating the axial, radial, and rotational forces that can be utilized with the torsion spring according to the principles of the present invention;

FIG. 12 is a cross-sectional view of an exemplary system in which a torsion spring, according to the principles of the present invention, is utilized for applying radial, axial, and rotational forces according to the principles of the present invention;

FIG. 13 is a schematic view of a fourth alternative embodiment of the torsion spring according to the principles of the present invention;

FIG. 14 is a schematic view of a fifth alternative embodiment of the torsion spring according to the principles of the present invention; and

FIG. 15 is a schematic view of a sixth alternative embodiment of the torsion spring according to the principles of the present invention.

### DETAILED DESCRIPTION OF THE PREFERRED EMBODIMENTS

The following description of the preferred embodiment(s) is merely exemplary in nature and is in no way intended to limit the invention, its application, or uses.

With reference to FIG. 3, a torsion spring 10, according to the principles of the present invention, is formed of a single wire having a first end 12 and a second end 14. The wire is wound to define a plurality of coil sections 16 each separated from one another by a plurality of torsion arms 18. First and second ends 12, 14 of the wire are joined to one another such that the plurality of coil sections 16 and plurality of torsion arms 18a, 18b combine to form a loop.

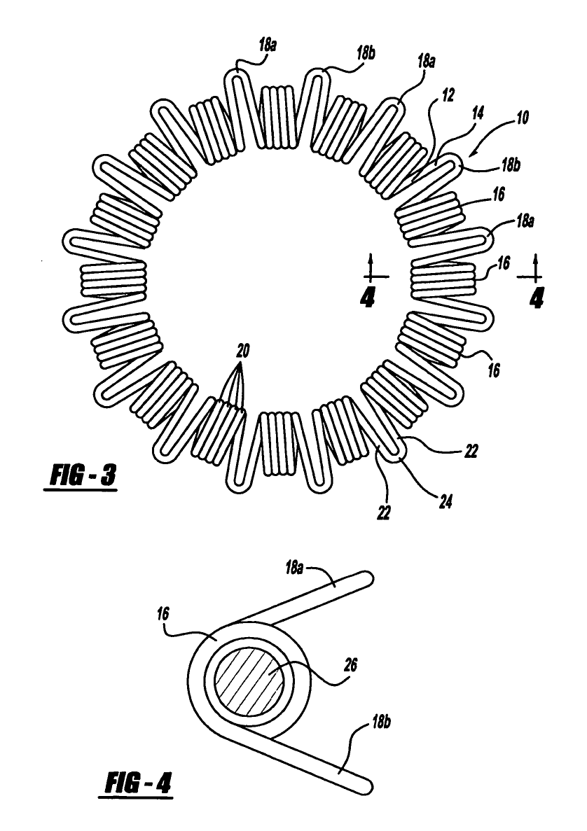

The torsion arms 18 include a first plurality of torsion arms 18a disposed on one side of the coil sections 16 and a second plurality of torsion arms 18b disposed on an opposite side of the coil sections 16. The first plurality of torsion arms 18a are alternately disposed with the second plurality of torsion arms 18b around the circumference of the spring 10 so that each torsion arm 18a, 18b is adjacent to oppositely disposed torsion arms as best illustrated in FIG. 4. Each of the coil sections 16 include a plurality of rings 20 which combine to define a coil section. As is known in the art, the number of rings in each coil section can be selectively chosen in order to provide a preferred spring characteristic.

As illustrated in FIG. 3, the torsion arms 18a, 18b, according to one embodiment, are generally U-shaped and include a pair of legs 22 each extending radially from adjacent coil sections 16 and terminating in a bridge section or bight 24 that attaches said pair of legs 22. The bridge section 24 is arcuate in shape in order to form the U-shaped torsion arms 18a, 18b. As illustrated in FIG. 4, the torsion spring 10 can optionally be provided with a reinforcing rod 26 in a form of a wire, cable, or other rod-like element extending through the center of the coil sections 16 in order to provide reinforcement or rigidity to the torsion spring 10, if deemed desirable or necessary in a given application.

With reference to FIG. 2, a clutch assembly, as described in the Background section of this application, is shown including a torsion spring 10, according to the principles of the present invention, and replacing the spring pack of the typical clutch system. The torsion arms 18a, 18b are provided against the retaining component 134 and the apply piston 122, respectively, and provide a return spring function to the clutch. With the torsion spring 10 of the present invention, the cost and complexity of the return spring in the clutch system is greatly reduced.

The torsion spring 10 of the present invention handles a linear force (the applied linear pressure force of the apply piston by transforming the force into a torque with respect to the spring) which is then absorbed by the wound spring material in the coil sections 16. The present invention chains several torsional spring elements together in a series to encircle the area which is used for a return spring in a clutch piston assembly system. The manufacturing of the torsional spring 10 is greatly simplified in comparison with the spring packs of conventional clutch designs. The manufacturing is similar to that of a standard torsional spring, except that several torsional spring elements are created from a single strand of material preferably with a constant cross-section, although a non-uniform cross-section can alternatively be used if varying stiffnesses are desired along the axial circumference of the spring 10. The two opposing ends 12, 14 of the chain of the torsional spring elements are joined together to create a garter-type spring in a manner that is well known in the garter-type spring art.

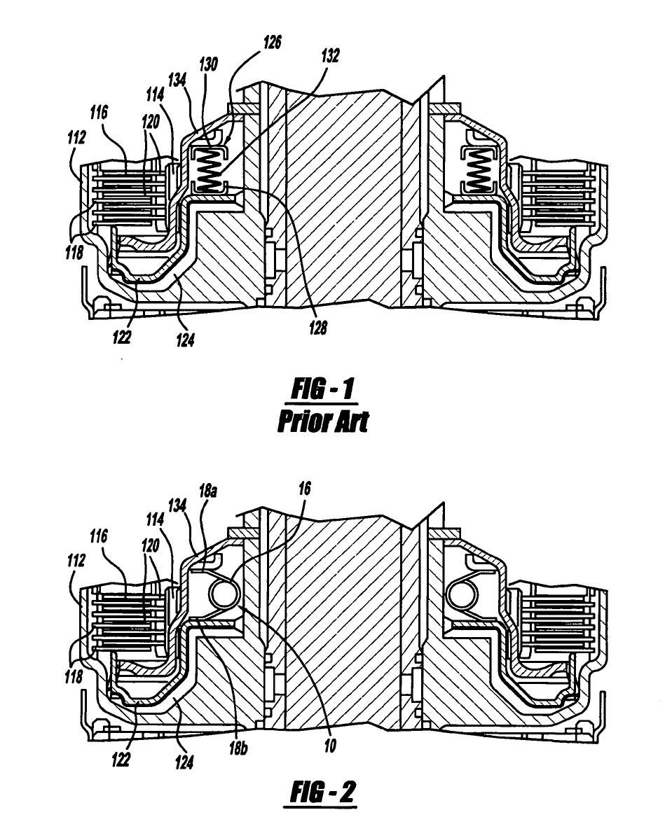

Cost reduction is a significant advantage of this simplified torsional spring design relative to a conventional spring pack. The present invention provides a substantial cost savings in that only one piece of raw material must be used which saves processing steps reducing time and energy. Furthermore, unlike a spring pack, no extraneous components are required to keep the spring intact. On a spring pack, stamped retaining components are required to hold the assembly together. The simplified torsional spring 10 of the present invention saves raw material cost and processing cost in comparison with the stamped retaining components required for the typical spring pack (FIG. 1). Relative to a collection of helical coil springs as utilized in a spring pack, the present invention provides significant product design flexibility in that minor changes to the geometry of the spring will result in the ability to provide linear or non-linear spring characteristics, as desired.

With reference to FIGS. 5 and 6, a torsional spring 60 is subjected to the action of a bending moment M=Fr, producing a normal stress in the wire. This is in contrast to a compression helical spring, in which the load produces a torsional stress in the wire. This means that the residual stresses built in during winding are in the same direction as, but of opposite sign to the working stresses which occur during use. These residual stresses are useful in making the spring stronger by opposing the working stress, provided the load is always applied so as to cause the spring to wind up. Because the residual stress opposes the working stress, torsional springs can be designed to operate at stress levels which equal, or even exceed, the yield strength of the wire.

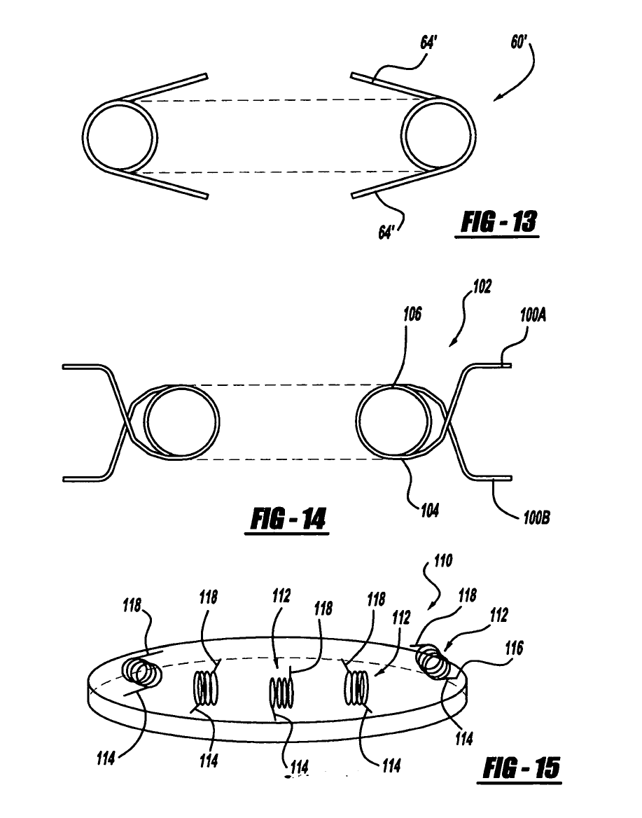

With the design, as illustrated in FIGS. 5 and 6, the moment arm length of the torsion arm can be varied by providing a curved end portion 62 to the arms 64 so that as the torsion arm 64 is bent, the moment arm length M_{O} is reduced, as illustrated by M1 in FIG. 6. Thus, by specifically designing a uniform or even a non-uniform curvature in the torsion arms 64, the moment arm M can be customized to provide varying spring rate characteristics at different loads or deflections. As illustrated in FIG. 13, the torsion arms 64′ of the torsional spring 60′ can extend radially inward as opposed to outward.

With reference to FIGS. 7 and 8, the torsion arms can include alternative designs, such as illustrated wherein the torsion arms 70 include a triangular configuration with a pair of legs 72 each extending radially from adjacent coil sections 74 and terminating in a bridge section 76 that attaches said pair of legs 72. The bridge section or bight 76 is straight and forms a base of the triangular-shaped torsion arm 70.

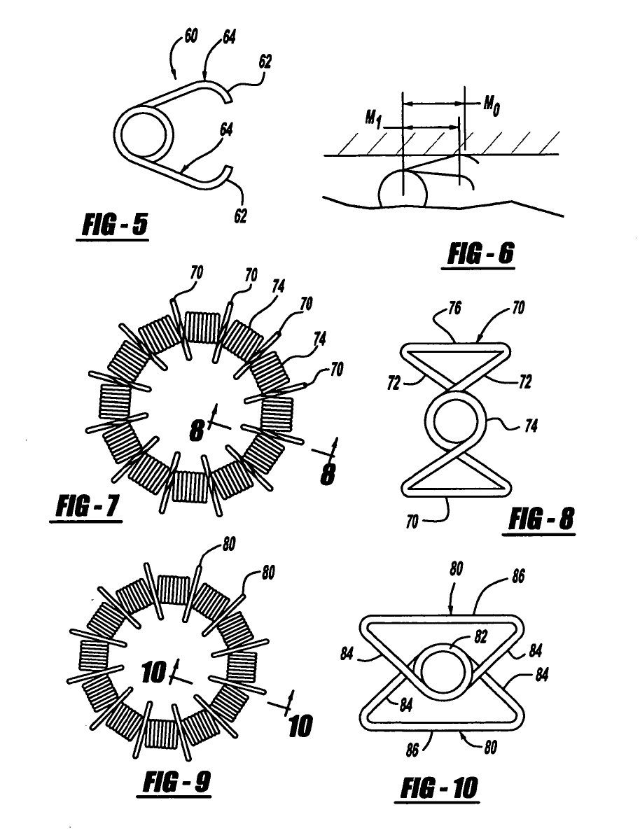

As illustrated in FIGS. 9 and 10, the triangular-shaped torsion arms 80 can also be utilized as extending radially from adjacent coil sections 82 on an opposite side of the coil section as the embodiment shown in FIGS. 7 and 8. The torsion arms 80 can have a triangular configuration including a pair of legs 84, each extending radially from adjacent coil sections 82 and terminating in a straight bridge section 86. With the spring design, as illustrated in FIGS. 7-10, the torsion arms 70, 80 are brought into closer alignment with the coil sections 74, 82.

With reference to FIG. 14, the torsion arms 100A, 100B can also be utilized as extending radially inwardly or outwardly with arms 100A extending from one axial side 104 of the torsion spring 102 and terminating at a position on an opposite axial side 106 of the torsion spring 102 so that adjacent arms 100A, 100B extend from opposite axial sides of the spring 102 and terminate on opposite axial sides of the torsion spring 102 in a cross-wise manner.

With reference to FIG. 15, the torsion spring 110 can be formed from individual torsion spring members 112 each having a first arm 114 joined to a joining member 116 such as a molded or cast substrate and a second arm 118 acting as a moment arm for providing the desired spring force. The joining member 116 can be in the form of a disc or ring shape having a round, oval, generally square, or rectangular configuration. The joining member 116 can be made from metal, plastic, or other suitable material with the first arm 114 of the torsion spring members 112 being embedded, adhered, or otherwise fastened thereto.

With reference to FIG. 11, one form of the torsion spring 10, according to the principles of the present invention, can be utilized to provide forces in three different directions. In particular, the torsional spring 10 of the present invention can be utilized much like a garter spring for providing radial forces Rₐ in an inward direction for providing a garter spring-type retaining function, while the torsion arms 18a, 18b provide an axial force A as described above with reference to the return spring. Furthermore, the torsional spring 10 can be utilized as a rotational biasing spring for applying a rotational force Rₒ by attaching the spring at one location X to a first member and attaching a separate portion of the spring to a second member rotatable relative to the first member at a location Y, such that upon relative rotation of the second member relative to the first member, the torsion spring 10 is loaded in a rotational direction so as to cause a first portion of the spring 10 to be compressed while a second portion of the spring 10 is extended. The rotational forces of the torsional spring 10 will cause the second member to either rotate along with the second member, or upon release of any force on the second member, would cause the second member to return to its original position.

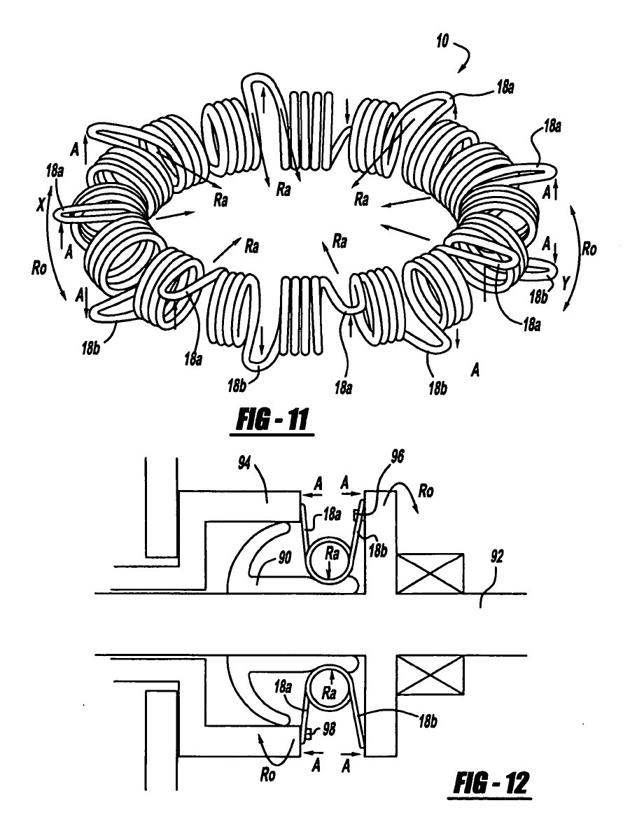

As illustrated in FIG. 12, the torsion spring 10 of the present invention is illustrated in a system in which all three, or any combination of one or more, of the spring forces A, Rₐ, Rₒ are utilized simultaneously. In particular, the torsion spring 10 is utilized as a garter-type spring for applying a radial force Rₐ for retaining a seal member 90 on a first shaft 92. The torsion arms 18a, 18b are utilized for providing an axial force A for biasing the first shaft member 92 in a first direction relative to a second shaft member 94. Also, the torsion spring 10 is connected at one side thereof 96 to the first shaft 92 and at a second side 98 thereof to the second shaft 94 so that relative rotation of the first shaft 92 relative to the second shaft 94 is resisted by the rotational force Rₒ of the spring 10.

Typically, springs are designed to handle one, or at most, two, types of forces. The torsion spring 10 of the present invention can handle three types of forces at one time, including axial (A), radial (Ra), and rotational (Ro) forces, as discussed above. Up until now, when choosing a way to counteract three forces of the types described above, a mechanical engineer would have elected to use two or more types of springs to deal with these forces. Since the present invention can be used to integrate any combination of the three counteracting forces in one spring, incorporating one spring instead of two or more provides a significant reduction in system cost.

The description of the invention is merely exemplary in nature and, thus, variations that do not depart from the gist of the invention are intended to be within the scope of the invention. Such variations are not to be regarded as a departure from the spirit and scope of the invention.

1. A spring, comprising:
a wire having a first and a second end and being wound to define a plurality of coil sections each separated from one another by a plurality of torsion arms, said first and second ends of said wire being joined to one another such that said plurality of coil sections and said plurality of torsion arms combine to form a loop.

2. The spring according to claim 1, wherein said torsion arms are generally U-shaped.

3. The spring according to claim 1, wherein each of said coil sections includes a plurality of rings.

4. The spring according to claim 1, wherein said loop is generally circular.

5. The spring according to claim 1, wherein said torsion arms are generally triangle shaped.

6. The spring according to claim 1, wherein said torsion arms extend radially outward from said loop.

7. The spring according to claim 1, wherein said torsion arms extend radially inward from said loop.

8. The spring according to claim 1, wherein said torsion arms extend axially from said loop.

9. The spring according to claim 1, wherein said torsion arms include a pair of legs each extending radially from adjacent coil sections and terminating in a bridge section that attaches said pair of legs, said bridge section defining an arc.

10. The spring according to claim 9, wherein ends of said pair of legs are curved within a common central plane of said loop.

11. The spring according to claim 1, wherein said torsion arms include a pair of legs each extending radially from adjacent coil sections and terminating in a bridge section that attaches said pair of legs, said bridge section being generally straight.

12. The spring according to claim 11, wherein said bridge section for adjacent torsion arms are disposed on opposite sides of said loop.

13. A clutch assembly, comprising:
a first member;
a second member rotatable relative to said first member;
a clutch pack including at least one first clutch disc attached to said first member and at least one second clutch disc attached to said second member;
an apply piston operable for applying axial pressure on said clutch pack; and
a return spring disposed against said apply piston and formed from a single wire including a plurality of coil sections each separated from one another by a plurality of torsion arms, said plurality of coil sections and said plurality of torsion arms combining to form a loop.

14. The clutch assembly according to claim 13, wherein said torsion arms are each engaged with one of said apply piston and a spring retainer surface.

15. The clutch assembly according to claim 13, wherein said torsion arms extend radially outward from said loop.

16. The clutch assembly according to claim 13, wherein said torsion arms extend radially inward from said loop.

17. The clutch assembly according to claim 13, wherein said torsion arms extend axially from said loop.

18. A spring system for applying spring forces in at least two of three different directions, comprising:
a first member;
a second member coaxial with said first member and rotatable relative to said first member;
a spring member formed from a wire having a first and a second end and being wound to define a plurality of coil sections each separated from one another by a plurality of torsion arms, said first and second ends of said wire being joined to one another such that said plurality of coil sections and said plurality of torsion arms combine to form a loop, said torsion arms being capable of biasing one of said first and second members in a first axial direction, said spring member also being capable of providing a bias force in a second rotational direction against one of said first and second members and said spring member being disposed around one of said first and second members for being capable of providing a force in a third radially inward direction.

19. The spring system according to claim 18, further comprising a seal member disposed between said spring member and said one of said first and second members.

20. The spring system according to claim 18, wherein said radially inward compressive force of said spring member retains a third member to one of said first and second members.

21. The spring system according to claim 18, wherein said spring member provides a spring force in each of said first, second and third directions.

22. A spring comprising:
a substrate member; and
a plurality of torsion spring members each having a coil section having a first torsion arm extending radially from said coil section and connected to said substrate member and a second torsion arm extending away from said substrate member.

23. The spring according to claim 22, wherein said substrate is molded with said first torsion arm of said plurality of torsion spring members embedded therein.

24. The spring according to claim 23, wherein said substrate is made from plastic.

25. The spring according to claim 23, wherein said substrate is made from metal.
